(19) United States
(12) Patent Application Publication
(10) Pub. No.: US 2023/0278567 A1
(43) Pub. Date: Sep. 7, 2023

(54) AUTONOMOUS DRIVING CONTROL APPARATUS AND METHOD THEREOF

(71) Applicants: Hyundai Motor Company, Seoul (KR); Kia Corporation, Seoul (KR); HYUNDAI AUTOEVER Corp., Seoul (KR)

(72) Inventors: Je Hyung Byun, Yongin-si (KR); Seung Jun Oh, Seogwipo-si (KR); Kyung Taek Kim, Anyang-si (KR)

(21) Appl. No.: 17/993,256

(22) Filed: Nov. 23, 2022

(30) Foreign Application Priority Data
Mar. 4, 2022 (KR) 10-2022-0028411

(51) Int. Cl. B60W 50/02; B60W 50/00; G07C 5/08; G07C 5/00

(52) U.S. Cl. CPC B60W 50/0205; B60W 50/0097; G07C 5/008; G07C 5/0816; B60W 2756/10

(57) ABSTRACT

An apparatus collects real-time driving information and real-time state information of an autonomous vehicle, receives a dataset from an external electronic device, selects a signal for collecting pieces of information of a plurality of parts, based on at least a portion of the dataset, identifies at least one policy associated with the selected signal, selects a first policy among the at least one policy, based on the at least a portion of the dataset, collects the signal, based on the first selected first policy, calculates a reference prediction value, based on the at least a portion of the dataset, compares the real-time driving information and the real-time state information with the calculated reference prediction value, and identifies states of the plurality of parts using the compared result.

### CROSS-REFERENCE TO RELATED APPLICATION

This application claims the benefit of priority to Korean Patent Application No. 10-2022-0028411, filed in the Korean Intellectual Property Office on Mar. 04, 2022, the entire contents of which are incorporated herein by reference.

### TECHNICAL FIELD

The present disclosure relates to a failure detection (e.g., in an autonomous driving control apparatus or any other apparatus) and a method thereof, and more particularly, relates to an apparatus for determining pieces of state information about parts of a vehicle (e.g., an autonomous vehicle) or whether there is a failure in each of the parts of the vehicle (e.g., using a dataset received from an external electronic device), and a method thereof.

### BACKGROUND

Some apparatuses, such as autonomous vehicles, robots, etc., may include a plurality of parts that may not properly operate due to various reasons. A reliable failure diagnosis of one or more parts may not be available for the apparatuses.

### SUMMARY

At least some autonomous vehicles may perform an operation of determining a deviation range associated with a change in characteristic value of each of a plurality of parts using a sensor (e.g., a legacy sensor or any other sensor) and vehicle data and dividing and predicting states or failure probabilities of parts based on a degree of the actually measured deviation. In this case, because the autonomous vehicle performs a part diagnosis using only information which is autonomously collected or generated, there is a limitation in deriving an accurate diagnosis result.

Particularly, it may be difficult to derive an adaptive diagnosis result for various parameters such as a model, a production time, a manufacturer, and a usage history of a vehicle and/or a part. Thus, there is a need to develop a technology capable of further considering the above-mentioned parameters and deriving a failure diagnosis result with higher accuracy.

An apparatus may comprise: a sensor device configured to collect real-time driving information of a vehicle and real-time state information of the vehicle, wherein the sensor device comprises at least one sensor; a storage to store the real-time state information and the real-time driving information; and a controller. The controller may be configured to: receive a dataset associated with the vehicle from an electronic device; select, based on at least a portion of the dataset, a signal for collecting pieces of information of a plurality of parts of the vehicle; identify at least one policy associated with the selected signal; select, based on the at least a portion of the dataset, a first policy associated with the signal among the at least one policy; collect, based on the selected first policy, the signal; calculate, based on the at least a portion of the dataset, a reference prediction value corresponding to at least one of a plurality of pieces of information comprised in the dataset; compare the calculated reference prediction value with at least one of: the real-time driving information; or the real-time state information; and determine, using a comparison result associated with the calculated reference prediction value, states of the plurality of parts.

The controller may be configured to select the first policy among the at least one policy, based on vehicle information and driving information of the vehicle. The vehicle information and the driving information may be comprised in the dataset, and the controller may be configured to determine, based on a comparison of a signal collected based on the first policy with the reference prediction value, whether there is a failure in at least one of the plurality of parts or whether it is necessary to replace at least one of the plurality of parts.

The controller may be configured to determine or update, based on the at least a portion of the dataset, a condition value for collecting the signal. The condition value may be comprised in the first policy. T=the condition value may comprise at least one of: a collection period for collecting the signal, a trigger signal, a collection period of time, or a state of the vehicle.

The controller may be configured to calculate, based on pieces of part information about the plurality of parts of the vehicle, the reference prediction value corresponding to at least one of the plurality of pieces of information. The pieces of part information may be comprised in the dataset. The pieces of part information may comprise at least one of: a part production time, a part model, a part number, or a part application vehicle.

The controller may be configured to calculate, based on vehicle information and driving information of the vehicle, the reference prediction value corresponding to at least one of the plurality of pieces of information. The vehicle information and the driving information may be comprised in the dataset. The vehicle information may comprise at least one of: a model of the vehicle, a production time of the vehicle, a failure code of the vehicle, engine state information of the vehicle, or battery information of the vehicle. The driving information may comprise at least one of: fuel efficiency of the vehicle, a driving distance of the vehicle, or a driving speed of the vehicle.

The plurality of pieces of information comprised in the dataset may comprise at least one of: driving information, vehicle information, part information, or characteristic information associated with the vehicle. The controller may be configured to calculate a plurality of reference prediction values comprising a driving information reference prediction value, a vehicle information reference prediction value, a part information reference prediction value, and a characteristic information reference prediction value. Each reference prediction value of the plurality of reference prediction values may respectively correspond to one of the plurality of pieces of information.

The controller may be configured to transmit, to the electronic device, failure prediction information comprising the reference prediction value and the comparison result.

The controller may be configured to receive, from the electronic device, a dataset updated based on the failure prediction information after transmitting the failure prediction information.

The plurality of parts may comprise a brake pad. The controller may be configured to: select a brake pedal ON time accumulation value as the signal; collect, based on the first policy, the signal; calculate the reference prediction value using a brake pad replacement time comprised in the dataset; compare the calculated reference prediction value with the real-time driving information by comparing the brake pedal ON time accumulation value identified based on the collected signal with the calculated reference prediction value; and display, on a display device and based on the brake pedal ON time accumulation value being greater than the reference prediction value, the comparison result comprising information indicating that it is necessary to replace the brake pad.

The controller may be configured to reset, based on the brake pad being replaced, the brake pedal ON time accumulation value and display, on the display device, a user interface comprising information indicating that the brake pad is replaced.

A method may comprise: collecting, by a sensor device, real-time driving information of a vehicle and real-time state information of the vehicle; receiving, by a controller, a dataset associated with the vehicle from an electronic device; selecting, by the controller and based on at least a portion of the dataset, a signal for collecting pieces of information of a plurality of parts of the vehicle; identifying, by the controller, at least one policy associated with the selected signal; selecting, by the controller and based on the at least a portion of the dataset, a first policy associated with the signal among the at least one policy; collecting, by the controller and based on the selected first policy, the signal; calculating, by the controller and based on the at least a portion of the dataset, a reference prediction value corresponding to at least one of a plurality of pieces of information comprised in the dataset; comparing, by the controller, the calculated reference prediction value with at least one of: the real-time driving information; or the real-time state information; and determining, by the controller and using a comparison result associated with the calculated reference prediction value, states of the plurality of parts.

The selecting the first policy may comprise selecting, based on vehicle information and driving information of the vehicle, the first policy among the at least one policy, wherein the vehicle information and the driving information are comprised in the dataset. The determining the states of the plurality of parts may comprise determining, based on a comparison of the signal collected based on the first policy with the reference prediction value, whether there is a failure in at least one of the plurality of parts or whether it is necessary to replace at least one of the plurality of parts.

The selecting the first policy may comprise determining or updating, based on the at least a portion of the dataset, a condition value for collecting the signal. The condition value may be comprised in the first policy, and the condition value may comprise at least one of: a collection period for collecting the signal, a trigger signal, a collection period of time, or a state of the vehicle.

The calculating the reference prediction value corresponding to at least one of the plurality of pieces of information comprised in the dataset may comprise: calculating, based on pieces of part information about the plurality of parts of the vehicle, the reference prediction value corresponding to at least one of the plurality of pieces of information. The pieces of part information may be comprised in the dataset. The pieces of part information may comprise at least one of: a part production time, a part model, a part number, or a part application vehicle.

The calculating the reference prediction value corresponding to at least one of the plurality of pieces of information comprised in the dataset may comprise: calculating, based on vehicle information and driving information of the vehicle, the reference prediction value corresponding to at least one of the plurality of pieces of information. The vehicle information and the driving information may be comprised in the dataset. The vehicle information may comprise at least one of: a model of the vehicle, a production time of the vehicle, a failure code of the vehicle, engine state information of the vehicle, or battery information of the vehicle. The driving information may comprise at least one of: fuel efficiency of the vehicle, a driving distance of the vehicle, or a driving speed of the vehicle.

The plurality of pieces of information comprised in the dataset may comprise at least one of: driving information, vehicle information, part information, or characteristic information associated with the vehicle. The calculating the reference prediction value may comprise: calculating a plurality of reference predication values comprising a driving information reference prediction value, a vehicle information reference prediction value, a part information reference prediction value, and a characteristic information reference prediction value. Each reference prediction value of the plurality of reference prediction values may respectively correspond to one of the plurality of pieces of information.

The method may further comprise transmitting, by the controller to the electronic device, failure prediction information comprising the reference prediction value and the comparison result.

The method may further comprise receiving, by the controller from the electronic device, a dataset updated based on the failure prediction information after transmitting the failure prediction information.

The plurality of parts may comprise a brake pad. The method may further comprise: selecting, by the controller, a brake pedal ON time accumulation value as the signal; collecting, by the controller and based on the first policy, the signal; calculating, by the controller, the reference prediction value using a brake pad replacement time comprised in the dataset; comparing, by the controller, the calculated reference prediction value with the real-time driving information by comparing the brake pedal ON time accumulation value identified based on the collected signal with the calculated reference prediction value; and displaying, on a display device and based on the brake pedal ON time accumulation value being greater than the reference prediction value, the comparison result comprising information indicating that it is necessary to replace the brake pad.

The method may further comprise: resetting, by the controller and based on the brake pad being replaced, the brake pedal ON time accumulation value; and displaying, by the controller and on the display device, a user interface comprising information indicating that the brake pad is replaced.

A method may comprise: collecting, by a sensor device, driving information of a vehicle and state information associated with at least one vehicle part of the vehicle; receiving, from an external device and via a communication interface, a dataset associated with the vehicle; selecting, by a controller and based on at least a portion of the dataset, a signal type for collecting pieces of information associated with the at least one vehicle part of the vehicle; collecting, by the controller and based on at least one policy associated with the selected signal type, at least one signal associated with the signal type; after collecting the at least one signal, calculating, by the controller and based on the at least a portion of the dataset, a reference prediction value; comparing, by the controller, the calculated reference prediction value with at least one of: the driving information; or the state information; and diagnosing, by the controller and using a comparison result associated with the calculated reference prediction value, a state of the at least one vehicle part.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a detailed configuration and operation of an autonomous driving control apparatus;

FIG. 2 is a drawing illustrating a detailed configuration and operation of an autonomous driving control apparatus;

FIG. 3 is an operational flowchart of an autonomous driving control apparatus;

FIG. 4 is an operational flowchart of an autonomous driving control apparatus; and

FIG. 5 is a block diagram illustrating a computing system.

### DETAILED DESCRIPTION

Hereinafter, some examples of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

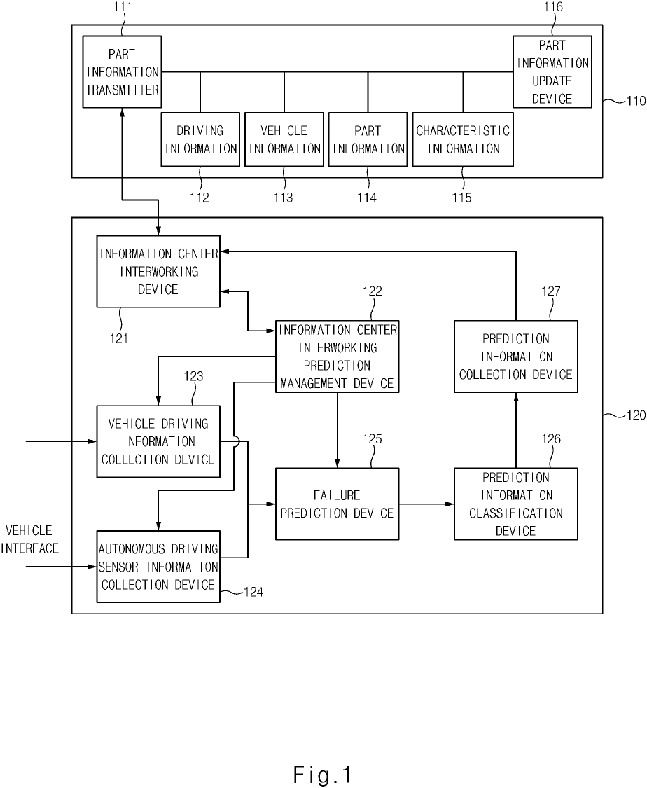

Hereinafter, various aspects of the present disclosure will be described in detail with reference to FIGS. 1 to 5. Furthermore, in a description of FIGS. 1 to 5, an operation described (e.g., as being performed by an autonomous driving control apparatus) may be understood as being performed or controlled by a controller included in the autonomous driving control apparatus or any other apparatuses (e.g., robots or any other vehicles).

FIG. 1 is a drawing illustrating a detailed configuration and operation of an autonomous driving control apparatus 120.

Referring to FIG. 1, the autonomous driving control apparatus 120 may transmit and receive various pieces of data to and from an information center 110.

The information center 110 may include a part information transmitter 111 and a part information update device 116. The part information transmitter 111 may be a transceiver to transmit and/or receive data, and may include a communication interface (e.g., a wired communication interface and/or a wireless communication interface).

The information center 110 may store driving information 112, vehicle information 113, part information 114, and characteristic information 115 and may update the driving information 112, the vehicle information 113, the part information 114, and the characteristic information 115, for example, using the part information update device 116.

For example, the information center 110 may transmit the driving information 112, the vehicle information 113, the part information 114, the characteristic information 115, or a combination thereof to the autonomous driving control apparatus 120 using the part information transmitter 111.

An apparatus (e.g., the autonomous driving control apparatus 120) may include an information center interworking device 121, an information center interworking prediction management device 122, a vehicle driving information collection device 123, an autonomous driving sensor information collection device 124, a failure prediction device 125, a prediction information classification device 126, and a prediction information collection device 127.

At least some of the components of the autonomous driving control apparatus 120 shown in FIG. 1 may be implemented by means of a controller and/or a sensor device, and respective components may be implemented in the form of software and/or hardware. Pieces of data obtained by means of components and/or data transmitted and received between components may be stored in a storage (not shown) of the autonomous driving control apparatus 120.

The autonomous driving control apparatus 120 may receive various pieces of data (or a dataset) from the information center 110 through the information center interworking device 121 and/or may transmit data associated with an autonomous vehicle to the information center 110.

For example, the autonomous driving control apparatus 120 may receive the driving information 112, the vehicle information 113, the part information 114, the characteristic information 115, or a combination thereof from the information center 110 through the information center interworking device 121.

For example, the autonomous driving control apparatus 120 may transmit failure prediction information (e.g., including a reference predication value and a compared result) to the information center 110 through the information center interworking device 121.

The information center interworking prediction management device 122 may determine a method where the autonomous driving control apparatus 120 collects prediction data and a method where the autonomous driving control apparatus 120 sets a threshold criterion in real time.

For example, the information center interworking prediction management device 122 may select a signal for collecting pieces of information of a plurality of parts included in the autonomous vehicle, for example, based on at least a portion of the dataset received from the information center interworking device 121.

As an example, the information center interworking prediction management device 122 may determine a brake pedal ON time accumulation value as information to be collected, for example, based on at least a portion of the received dataset, and may select a signal for collecting the determined information. The brake pedal ON time accumulation value may indicate a sum of a plurality of time periods during which a braking operation is performed (e.g., a brake pedal is pressed). The brake pedal ON time accumulation value may be reset (e.g., to zero or any other value), for example, if one or more brake pads are replaced. In this case, the autonomous driving control apparatus 120 may determine whether there is a failure associated with a brake pad among the plurality of parts included in the autonomous vehicle or whether it is necessary to replace the brake pad (e.g., determining a replacement event for the brake pad).

The information center interworking prediction management device 122 may identify at least one policy associated with the selected signal, for example, based on at least a portion of the dataset received from the information center interworking device 121. The information center interworking prediction management device 122 may select a first policy associated with the selected signal among the at least one identified policy as a policy for signal collection.

The information center interworking prediction management device 122 may transmit a control signal for collecting a signal, for example, based on the selected first policy to the vehicle driving information collection device 123 and/or the autonomous driving sensor information collection device 124.

The information center interworking prediction management device 122 may diversify a failure prediction level corresponding to each of the plurality of parts, for example, based on at least a portion of the dataset received from the information center interworking device 121.

As an example, the information center interworking prediction management device 122 may transmit a control signal for diversifying the failure prediction level to the failure prediction device 125, based on at least some of vehicle information, driving information, part information, and/or characteristic information of the autonomous vehicle.

As an example, the information center interworking prediction management device 122 may calculate a reference prediction value corresponding to each of a plurality of pieces of information. The reference prediction value may be calculated, for example, based on at least some of the vehicle information, the driving information, the part information, and/or the characteristic information of the autonomous vehicle.

As an example, the vehicle information may include fuel efficiency of the autonomous vehicle, a model of the autonomous vehicle, a production time of the autonomous vehicle, a failure code of the autonomous vehicle, or a combination thereof.

As an example, the driving information may include a driving speed of the autonomous vehicle, engine state information of the autonomous vehicle, battery information of the autonomous vehicle, or a combination thereof.

As an example, the part information may include a model of each of the plurality of parts (e.g., a brake pad) included in the autonomous vehicle, a production time of each of the plurality of parts, a vehicle applied to each of the plurality of parts, a part number of each of the plurality of parts, a part application vehicle, or a combination thereof. If the selected signal is a brake pedal ON time accumulation value, the autonomous driving control apparatus may calculate a part information reference prediction value using a brake pad replacement time included in the part information.

As an example, the characteristic information may include the number of field failures of the autonomous vehicle, a failure determination criterion of the autonomous vehicle, or a combination thereof.

The failure prediction device 125 may calculate a reference prediction value associated with a part failure (e.g., whether a failure for each part occurs). The reference prediction value associated with a part failure may be calculated, for example, based on the control signal received from the information center interworking prediction management device 122.

For example, the failure prediction device 125 may compare the calculated reference prediction value (e.g., with real-time information of the autonomous vehicle, which may be obtained using a sensor device) to determine whether there is a failure in a part of the vehicle or whether it is necessary to replace the part.

As an example, the failure prediction device 125 may compare the brake pedal ON time accumulation value (e.g., collected by means of the vehicle driving information collection device 123 and/or the autonomous driving sensor information collection device 124) with the calculated part information reference prediction value to determine whether there is a failure in the brake pad or whether it is necessary to replace the brake pad based on the compared result.

As an example, if the brake pedal ON time accumulation value is greater than the reference prediction value, the failure prediction device 125 may provide a driver with information that it is necessary to replace the brake pad (e.g., output a notification signal/message indicating that a brake pad needs to be replaced). For example, the autonomous driving control apparatus may display information associated with a replacement of the brake pad on a display device.

The vehicle driving information collection device 123 may collect driving information of the autonomous vehicle.

For example, the vehicle driving information collection device 123 may collect real-time driving information of the autonomous vehicle based on a specified method. The real-time driving information may be collected, for example, based on the control signal received from the information center interworking prediction management device 122.

The autonomous driving sensor information collection device 124 may collect state information of the autonomous vehicle.

For example, the autonomous driving sensor information collection device 124 may collect real-time state information of the autonomous vehicle based on a specified method. The real-time state information may be collected, for example, based on the control signal received from the information center interworking prediction management device 122.

The vehicle driving information collection device 123 and the autonomous driving sensor information collection device 124 may include, or may be implemented as, one or more sensor devices.

The prediction information classification device 126 may collect, classify, and store pieces of information including the reference prediction value, the vehicle driving information, the autonomous driving sensor information, or the combination thereof, which may be received from the failure prediction device 125.

The prediction information collection device 127 may collect failure prediction information or the like stored in the autonomous vehicle and may transmit at least a portion of the collected information to the information center 110, for example, via the information center interworking device 121.

For example, the information center 110 may store the driving information 112, the vehicle information 113, the part information 114, and/or the characteristic information 115. The information center 110 may store the driving information 112, the vehicle information 113, the part information 114, and/or the characteristic information 115, for example, using the information transmitted from the prediction information collection device 127.

For example, the information center 110 may update and store the information, transmitted from the prediction information collection device 127, by means of the part information update device 116. The updated information may be stored in the information center 110.

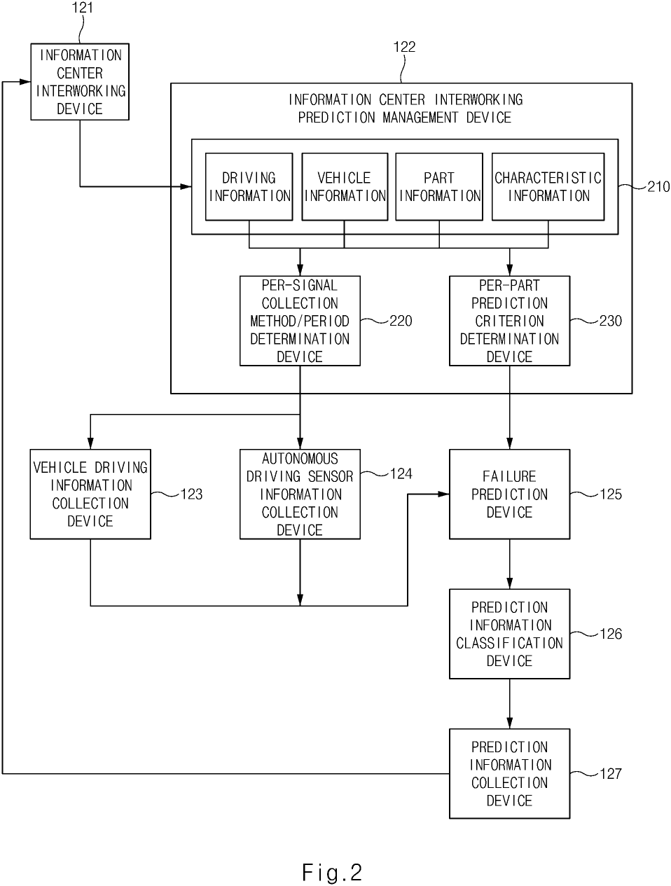

Hereinafter, with respect to FIG. 2, an example configuration and operation of the information center interworking prediction management device 122 of FIG. 1 will be described in more detail. Furthermore, a description of a component having the same name as the component of FIG. 1 among components of FIG. 2 may be replaced with the above-mentioned description of FIG. 1, and a redundant description for the same component may be omitted for conciseness.

FIG. 2 is a drawing illustrating a detailed configuration and operation of an autonomous driving control apparatus (e.g., an autonomous driving control apparatus 120 of FIG. 1).

The autonomous driving control apparatus may transmit data (e.g., a dataset 210), received from an information center interworking device 121, to an information center interworking prediction management device 122.

The information center interworking prediction management device 122 may select a signal for collecting pieces of information of a plurality of parts included in an autonomous vehicle, for example, based on at least a portion of the data (e.g., the received dataset 210).

The information center interworking prediction management device 122 may identify/determine at least one policy associated with the selected signal and may select the at least one policy.

The information center interworking prediction management device 122 may identify at least one policy, for example, based on at least a portion of the received dataset 210. The information center interworking prediction management device 122 may select a first policy associated with the signal among the identified policies.

The information center interworking prediction management device 122 may include a per-signal collection method/period determination device 220 which may determine and/or update a condition value for collecting the selected signal, which may be included in the first policy, using the dataset 210.

For example, the per-signal collection method/period determination device 220 may determine or update a collection period (e.g., 1 second, 10 ms, or any other period) for collecting the selected signal, a trigger signal for initiating the collection (e.g., generation of a specific signal of an autonomous vehicle), a collection period of time, a state of the autonomous vehicle, or a combination thereof.

The autonomous driving control apparatus may transmit the condition value for collecting the signal, which may be determined or updated by the per-signal collection method/period determination device 220. The condition value may be transmitted (e.g., from the per-signal collection method/period determination device 220) to a vehicle driving information collection device 123 and/or an autonomous driving sensor information collection device 124.

For example, the vehicle driving information collection device 123 may collect real-time driving information of the autonomous vehicle based a specified method. The real-time driving information may be received/collected, for example, based on the condition value for collecting the signal, which may be received from the per-signal collection method/period determination device 220.

As an example, the vehicle driving information collection device 123 may transmit the collected real-time driving information to a failure prediction device 125.

As an example, the vehicle driving information collection device 123 may store the collected real-time driving information in a storage (not shown).

For example, the autonomous driving sensor information collection device 124 may collect real-time state information of the autonomous vehicle based a specified method. The real-time state information may be received/collected, for example, based on the condition value for collecting the signal, which may be received from the per-signal collection method/period determination device 220.

As an example, the autonomous driving sensor information collection device 124 may transmit the collected real-time state information to the failure prediction device 125.

As an example, the autonomous driving sensor information collection device 124 may store the collected real-time state information in the storage (not shown).

The information center interworking prediction management device 122 may include a per-part prediction criterion determination device 230, which may determine a prediction criterion for each of a plurality of parts using the dataset 210.

For example, the per-part prediction criterion determination device 230 may determine a criterion for calculating a reference prediction value, which may be used for determining whether there is a failure in each of the plurality of parts included in the autonomous vehicle.

As an example, the per-part prediction criterion determination device 230 may determine the criterion for calculating the reference prediction value, for example, based on part information of the autonomous vehicle, which may be included in the dataset 210. The reference prediction value (and/or the criterion for calculating the reference prediction value) may correspond to each of the plurality of pieces of information. The reference prediction value (and/or the criterion for calculating the reference prediction value) may correspond to a respective one of the plurality of pieces of information.

As an example, the part information may include a part production period, a part model, a part number, a part application vehicle, or a combination thereof.

For example, the per-part prediction criterion determination device 230 may transmit the calculated criterion to the failure prediction device 125.

The failure prediction device 125 may compare the real-time information of the autonomous vehicle with the reference prediction value.

For example, the failure prediction device 125 may calculate a reference prediction value corresponding to each of pieces of information included in the dataset 210. The reference prediction value may be calculated, for example, using the criterion received from the per-part prediction criterion determination device 230.

For example, the failure prediction device 125 may compare the real-time driving information with the real-time state information, which may be respectively received from the vehicle driving information collection device 123 and the autonomous driving sensor information collection device 124.

For example, the failure prediction device 125 may identify a state of each of the plurality of parts using the compared result. For example, the failure prediction device 125 may identify whether there is a failure in each of the plurality of parts using the compared result.

For example, the failure prediction device 125 may transmit the identified result to a prediction information classification device 126.

The prediction information classification device 126 may collect, classify, and store pieces of information, which may include the identified result received from the failure prediction device 125, and may include a reference prediction value, vehicle driving information, autonomous driving sensor information, or a combination thereof. As an example, the prediction information classification device 126 may transmit at least some of the classified and stored data to a prediction information collection device 127.

The prediction information collection device 127 may collect data transmitted through the predication information classification device 126 and failure prediction information or the like stored in the autonomous vehicle and may transmit at least some of the pieces of received and collected information to an information center 110 of FIG. 1 (e.g., via the information center interworking device 121).

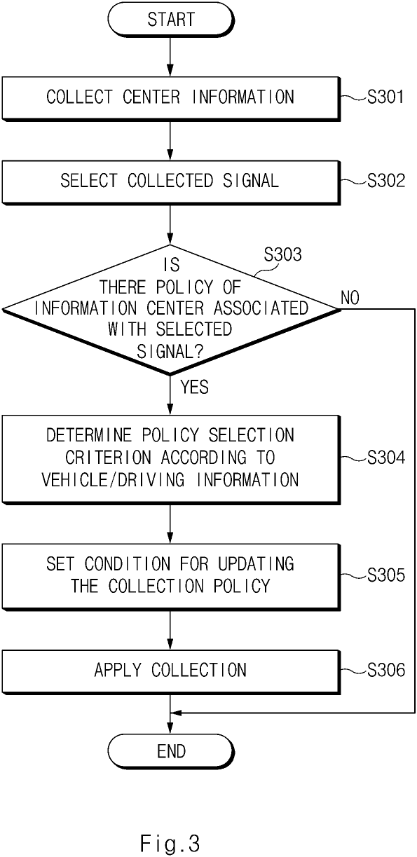

FIG. 3 is an operational flowchart of an autonomous driving control apparatus.

FIG. 3 is a flowchart illustrating an autonomous driving control method. Hereinafter, it is assumed that an autonomous driving control apparatus having components of FIG. 1 performs a process of FIG. 3. Furthermore, in a description of FIG. 3, an operation described as being performed by the autonomous driving control apparatus may be understood as being controlled by a controller of the autonomous driving control apparatus of FIGS. 1 or 2 or any other controller.

Referring to FIG. 3, in S301, the autonomous driving control apparatus (e.g., an autonomous driving control apparatus 120 of FIG. 1) may collect center information.

As an example, the autonomous driving control apparatus may receive (e.g., collect) data transmitted from an information center (e.g., an information center 110 of FIG. 1) through an information center interworking device (e.g., an information center interworking device 121 of FIG. 1).

In S302, the autonomous driving control apparatus may select at least some of the collected signals.

As an example, the autonomous driving control apparatus may select a signal for collecting pieces of information of a plurality of parts included in an autonomous vehicle, based on at least a portion of the received dataset.

In S303, the autonomous driving control apparatus may identify whether there is a policy of the information center associated with the selected signal.

As an example, if it is identified that there is a policy of the information center associated with the selected signal, the autonomous driving control apparatus may perform step S304.

As an example, if it is identified that there is no policy of the information center associated with the selected signal, the autonomous driving control apparatus may end the operation.

In S304, the autonomous driving control apparatus may determine a policy selection criterion, for example, according to vehicle/driving information.

As an example, the autonomous driving control apparatus may determine a policy selection criterion based on information about at least a portion of the dataset (e.g., vehicle information and driving information of the autonomous vehicle) and may select a first policy associated with a signal for collection as a policy for signal collection based on the determined criterion.

In S305, the autonomous driving control apparatus may set a condition for updating the collection policy.

As an example, the autonomous driving control apparatus may determine or update a condition value for collecting a signal, for example, based on at least some of a plurality of pieces of information (e.g., driving information, vehicle information, part information, and/or characteristic information) included in the dataset. The condition value (and/or the signal) may be included in the first policy. The condition value may include a collection period for collecting the signal, a trigger signal, a collection period of time, a state of the autonomous vehicle, or a combination thereof.

In S306, the autonomous driving control apparatus may apply the collection.

As an example, the autonomous driving control apparatus may collect real-time information (e.g., real-time driving information and real-time state information) associated with the autonomous vehicle using a vehicle driving information collection device (e.g., a vehicle driving information collection device 123 of FIG. 1) and/or an autonomous driving sensor information collection device (e.g., an autonomous driving sensor information collection device 124 of FIG. 1), based on the finally determined first policy.

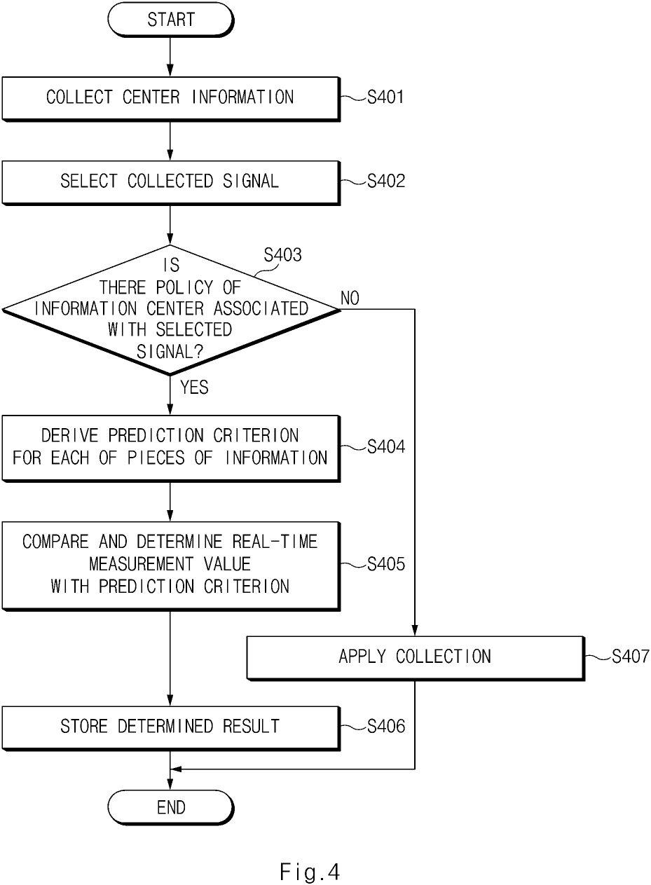

FIG. 4 is an operational flowchart of an autonomous driving control apparatus.

FIG. 4 is a flowchart illustrating an autonomous driving control method. Hereinafter, it is assumed that an autonomous driving control apparatus having components of FIG. 1 performs a process of FIG. 4. Furthermore, with respect to FIG. 4, an operation described as being performed by the autonomous driving control apparatus may be understood as being controlled by a controller of the autonomous driving control apparatus of FIGS. 1 or 2 (or any other controller).

Referring to FIG. 4, in S401, the autonomous driving control apparatus (e.g., an autonomous driving control apparatus 120 of FIG. 1) may collect center information.

As an example, the autonomous driving control apparatus may receive (e.g., collect receive) data transmitted from an information center (e.g., an information center 110 of FIG. 1) via an information center interworking device (e.g., an information center interworking device 121 of FIG. 1).

In S402, the autonomous driving control apparatus may select at least some of the collected signals.

As an example, the autonomous driving control apparatus may select a signal for collecting pieces of information of a plurality of parts included in an autonomous vehicle based on at least a portion of the received dataset.

In S403, the autonomous driving control apparatus may identify whether there is a policy of the information center associated with the selected signal.

As an example, if it is identified/determined that there is the policy of the information center associated with the selected signal, the autonomous driving control apparatus may perform step S404.

As an example, if it is identified/determined that there is no policy of the information center associated with the selected signal, the autonomous driving control apparatus may perform step S407.

In S404, the autonomous driving control apparatus may derive a prediction criterion for each of pieces of information included in the dataset.

For example, the autonomous driving control apparatus may calculate a reference prediction value (e.g., a driving information reference prediction value, a vehicle information reference prediction value, a part information reference prediction value, a characteristic information reference prediction value, etc.) corresponding to one or more of a plurality of pieces of information (e.g., driving information, vehicle information, part information, and characteristic information) included in the dataset received from the information center, based on at least a portion of the dataset.

As an example, the autonomous driving control apparatus may calculate a driving information reference prediction value corresponding to the driving information included in the dataset among the plurality of pieces of information, based on the driving information. The driving information may include, for example, a driving speed, engine state information, battery information, or a combination thereof.

As an example, the autonomous driving control apparatus may calculate a vehicle information reference prediction value corresponding to the vehicle information included in the dataset among the plurality of pieces of information, based on the vehicle information. The vehicle information may include, for example, fuel efficiency of the autonomous vehicle, a model of the autonomous vehicle, a production time of the autonomous vehicle, a failure code of the autonomous vehicle, a driving distance of the autonomous vehicle, or a combination thereof.

As an example, the autonomous driving control apparatus may calculate a part information reference prediction value corresponding to the part information included in the dataset among the plurality of pieces of information, based on the part information. The part information may include, for example, a part production time, a part model, a part number, a part application vehicle, or a combination thereof.

As an example, the autonomous driving control apparatus may calculate a characteristic information reference prediction value corresponding to the characteristic information included in the dataset among the plurality of pieces of information, based on the characteristic information. The characteristic information may include, for example, the number of field failures, a failure determination criterion, or a combination thereof.

In S405, the autonomous driving control apparatus may compare a real-time measurement value with a prediction criterion, for example, to determine whether there is a failure in one or more parts of the vehicle based on the compared result.

As an example, the autonomous driving control apparatus may compare real-time driving information and real-time state information obtained using a sensor device (e.g., the vehicle driving information collection device and/or the autonomous driving sensor information collection device) with a reference prediction value calculated in response to a corresponding one of the plurality of pieces of information, for example, to identify a state of the corresponding one of the plurality of parts (e.g., whether there is a failure in the corresponding one of the plurality of parts or whether it is necessary to replace the corresponding one of the plurality of parts) using the compared result. Additionally or alternatively, a reference prediction value may be obtained, for example, based on each of the plurality of pieces of information to identify a state of each of the plurality of parts.

In S406, the autonomous driving control apparatus may store the result (e.g., failure prediction information) of the determination performed in step S405.

As an example, the autonomous driving control apparatus may store the result of the determination in a storage and may transmit the result of the determination to the information center through the information center interworking device.

As an example, after transmitting the result of the determination to the information center, the autonomous driving control apparatus may receive an updated dataset which may be transmitted after being updated based on the result of the determination by the information center.

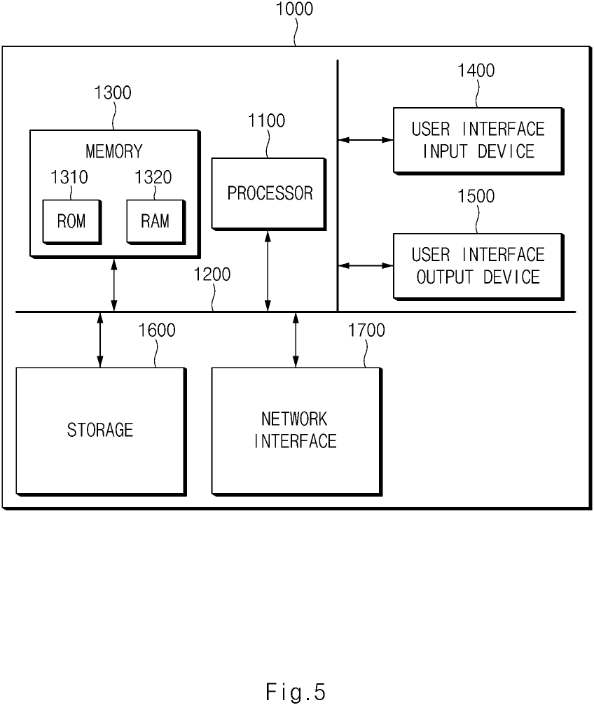

FIG. 5 is a block diagram illustrating a computing system.

Referring to FIG. 5, a computing system 1000 may include at least one processor 1100, a memory 1300, a user interface input device 1400, a user interface output device 1500, storage 1600, and a network interface 1700, which may be connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the features disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the autonomous driving control apparatus and the method thereof.

According to at least one of examples of the present disclosure, the autonomous driving control apparatus and the method thereof may be provided to identify a state of each of a plurality of parts of an autonomous vehicle and whether there is a failure in each of the plurality of parts of the autonomous vehicle.

Furthermore, according to at least one of examples of the present disclosure, the autonomous driving control apparatus and the method thereof may be provided to efficiently and adaptively identify states of parts and/or whether there is a failure in each of the parts.

In addition, various effects ascertained directly or indirectly through the present disclosure may be provided.

An aspect of the present disclosure provides an autonomous driving control apparatus for identifying states of a plurality of parts and whether there is a failure in each of the plurality of parts by adaptively using various parameters and a method thereof.

Another aspect of the present disclosure provides an autonomous driving control apparatus for identifying states of a plurality of parts included in an autonomous vehicle using data received from an external electronic device (e.g., a data center or a server) and a method thereof.

Another aspect of the present disclosure provides an autonomous driving control apparatus for performing an operation of determining a condition (e.g., a collection period, a collection trigger signal, a collection period of time, or a state of a vehicle for collection) for collecting information or a signal associated with a plurality of parts based on vehicle information, driving information, part information, and/or characteristic information and a method thereof.

Another aspect of the present disclosure provides an autonomous driving control apparatus for performing an operation of calculating a reference prediction value for identifying a state of a part using a production time of each of a plurality of parts, a manufacturer of each of the plurality of parts, a part number of each of the plurality of parts, fuel efficiency of an autonomous vehicle, a driving distance of the autonomous vehicle, a driving speed of the autonomous vehicle, engine state information of the autonomous vehicle, and/or battery information of the autonomous vehicle and a method thereof.

Another aspect of the present disclosure provides an autonomous driving control apparatus for performing an operation of comparing a signal collected through a specified policy with a calculated reference prediction value, transmitting the compared result to an external electronic device, receiving a dataset updated based on the compared result from the external electronic device, and adaptively identifying a state of a part or whether there is a failure in the part using the updated dataset and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an autonomous driving control apparatus may include a sensor device that collects real-time driving information and real-time state information of an autonomous vehicle and include at least one sensor, a storage storing the real-time state information and the real-time driving information, and a controller that receives a dataset associated with the autonomous vehicle from an external electronic device, select a signal for collecting pieces of information of a plurality of parts included in the autonomous vehicle, based on at least a portion of the dataset, identify at least one policy associated with the selected signal, select a first policy associated with the signal among the at least one policy, based on the at least a portion of the dataset, collect the signal, based on the selected first policy, calculate a reference prediction value corresponding to each of a plurality of pieces of information included in the dataset, based on the at least a portion of the dataset, compare the real-time driving information and the real-time state information included in the collected signal with the calculated reference prediction value, and identify states of the plurality of parts using the compared result.

The controller may select the first policy among the at least one policy, based on vehicle information and driving information of the autonomous vehicle, the vehicle information and the driving information being included in the dataset and may identify whether there is a failure in each of the plurality of parts or whether it is necessary to replace each of the plurality of parts, using the result of comparing the signal collected based on the first policy with the reference prediction value.

The controller may determine or update a condition value for collecting the signal, the condition value being included in the first policy, based on the at least a portion of the dataset. The condition value may include a collection period for collecting the signal, a trigger signal, a collection period of time, a state of the autonomous vehicle, or a combination thereof.

The controller may calculate the reference prediction value corresponding to each of the plurality of pieces of information, based on pieces of part information about the plurality of parts of the autonomous vehicle, the pieces of part information being included in the dataset. The pieces of part information may include a part production time, a part model, a part number, a part application vehicle, or a combination thereof.

The controller may calculate the reference prediction value corresponding to each of the plurality of pieces of information, based on vehicle information and driving information of the autonomous vehicle, the vehicle information and the driving information being included in the dataset. The vehicle information and the driving information may include fuel efficiency of the autonomous vehicle, a model of the autonomous vehicle, a production time of the autonomous vehicle, a failure code of the autonomous vehicle, a driving distance of the autonomous vehicle, a driving speed of the autonomous vehicle, engine state information of the autonomous vehicle, battery information of the autonomous vehicle, or a combination thereof.

The plurality of pieces of information included in the dataset may include driving information, vehicle information, part information, and characteristic information associated with the autonomous vehicle. The controller may calculate a driving information reference prediction value, a vehicle information reference prediction value, a part information reference prediction value, and a characteristic information reference prediction value respectively corresponding to the plurality of pieces of information.

The controller may transmit failure prediction information including the reference prediction value and the compared result to the external electronic device.

The controller may receive a dataset updated based on the failure prediction information from the external electronic device, after transmitting the failure prediction information.

The plurality of parts may include a brake pad. The controller may select a brake pedal ON time accumulation value as the signal, may collect the signal, based on the first policy, may calculate the reference prediction value using a brake pad replacement time included in the dataset, may compare the brake pedal ON time accumulation value identified based on the collected signal with the calculated reference prediction value, and may display the compared result including information that it is necessary to replace the brake pad on a display device, when the brake pedal ON time accumulation value is greater than the reference prediction value.

The controller may reset the brake pedal ON time accumulation value, when it is identified that the brake pad is replaced and may display a user interface including information identifying that the brake pad is replaced on the display device.

According to an aspect of the present disclosure, an autonomous driving control method may include collecting, by a sensor device, real-time driving information and real-time state information of an autonomous vehicle, receiving, by a controller, a dataset associated with the autonomous vehicle from an external electronic device, selecting, by the controller, a signal for collecting pieces of information of a plurality of parts included in the autonomous vehicle, based on at least a portion of the dataset, identifying, by the controller, at least one policy associated with the selected signal, selecting, by the controller, a first policy associated with the signal among the at least one policy, based on the at least a portion of the dataset, collecting, by the controller, the signal, based on the selected first policy, calculating, by the controller, a reference prediction value corresponding to each of a plurality of pieces of information included in the dataset, based on the at least a portion of the dataset, comparing, by the controller, the real-time driving information and the real-time state information included in the collected signal with the calculated reference prediction value, and identifying, by the controller, states of the plurality of parts using the compared result.

The selecting of the first policy and the identifying of the states of the plurality of parts by the controller may include selecting the first policy among the at least one policy, based on vehicle information and driving information of the autonomous, the vehicle information and driving information being included in the dataset, and identifying whether there is a failure in each of the plurality of parts or whether it is necessary to replace each of the plurality of parts, using the result of comparing the signal collected based on the first policy with the reference prediction value.

The selecting of the first policy by the controller may include determining or updating a condition value for collecting the signal, the condition value being included in the first policy, based on the at least a portion of the dataset. The condition value may include a collection period for collecting the signal, a trigger signal, a collection period of time, a state of the autonomous vehicle, or a combination thereof.

The calculating of the reference prediction value corresponding to each of the plurality of pieces of information included in the dataset by the controller may include calculating the reference prediction value corresponding to each of the plurality of pieces of information, based on pieces of part information about the plurality of parts of the autonomous vehicle, the pieces of part information being included in the dataset. The pieces of part information may include a part production time, a part model, a part number, a part application vehicle, or a combination thereof.

The calculating of the reference prediction value corresponding to each of the plurality of pieces of information included in the dataset by the controller may include calculating the reference prediction value corresponding to each of the plurality of pieces of information, based on vehicle information and driving information of the autonomous vehicle, the vehicle information and the driving information being included in the dataset. The vehicle information and the driving information may include fuel efficiency of the autonomous vehicle, a model of the autonomous vehicle, a production time of the autonomous vehicle, a failure code of the autonomous vehicle, a driving distance of the autonomous vehicle, a driving speed of the autonomous vehicle, engine state information of the autonomous vehicle, battery information of the autonomous vehicle, or a combination thereof.

The plurality of pieces of information included in the dataset may include driving information, vehicle information, part information, and characteristic information associated with the autonomous vehicle. The calculating of the reference prediction value corresponding to each of the plurality of pieces of information included in the dataset by the controller may include calculating a driving information reference prediction value, a vehicle information reference prediction value, a part information reference prediction value, and a characteristic information reference prediction value respectively corresponding to the plurality of pieces of information.

The autonomous driving control method may further include transmitting, by the controller, failure prediction information including the reference prediction value and the compared result to the external electronic device.

The autonomous driving control method may further include receiving, by the controller, a dataset updated based on the failure prediction information from the external electronic device, after transmitting the failure prediction information.

The plurality of parts may include a brake pad. The autonomous driving control method may further include selecting a brake pedal ON time accumulation value as the signal, collecting the signal, based on the first policy, calculating the reference prediction value using a brake pad replacement time included in the dataset, comparing the brake pedal ON time accumulation value identified based on the collected signal with the calculated reference prediction value, and displaying the compared result including information that it is necessary to replace the brake pad on a display device, when the brake pedal ON time accumulation value is greater than the reference prediction value.

The autonomous driving control method may further include resetting the brake pedal ON time accumulation value, when it is identified that the brake pad is replaced, and displaying a user interface including information identifying that the brake pad is replaced on the display device.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, aspects of the present disclosure are not intended to limit the technical spirit of the present disclosure but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus comprising:
a sensor device configured to collect real-time driving information of a vehicle and real-time state information of the vehicle, wherein the sensor device comprises at least one sensor;
a storage to store the real-time state information and the real-time driving information; and
a controller configured to:
receive a dataset associated with the vehicle from an electronic device;
select, based on at least a portion of the dataset, a signal for collecting pieces of information of a plurality of parts of the vehicle;
identify at least one policy associated with the selected signal;
select, based on the at least a portion of the dataset, a first policy associated with the signal among the at least one policy;
collect, based on the selected first policy, the signal;
calculate, based on the at least a portion of the dataset, a reference prediction value corresponding to at least one of a plurality of pieces of information comprised in the dataset;
compare the calculated reference prediction value with at least one of:
the real-time driving information; or the real-time state information; and
determine, using a comparison result associated with the calculated reference prediction value, states of the plurality of parts.

2. The apparatus of claim 1, wherein the controller is configured to select the first policy among the at least one policy, based on vehicle information and driving information of the vehicle, wherein the vehicle information and the driving information are comprised in the dataset, and wherein the controller is configured to determine, based on a comparison of a signal collected based on the first policy with the reference prediction value, whether there is a failure in at least one of the plurality of parts or whether it is necessary to replace at least one of the plurality of parts.

3. The apparatus of claim 1, wherein the controller is configured to determine or update, based on the at least a portion of the dataset, a condition value for collecting the signal,
wherein the condition value is comprised in the first policy, and
wherein the condition value comprises at least one of: a collection period for collecting the signal, a trigger signal, a collection period of time, or a state of the vehicle.

4. The apparatus of claim 1, wherein the controller is configured to calculate, based on pieces of part information about the plurality of parts of the vehicle, the reference prediction value corresponding to at least one of the plurality of pieces of information, wherein the pieces of part information are comprised in the dataset, and
wherein the pieces of part information comprise at least one of: a part production time, a part model, a part number, or a part application vehicle.

5. The apparatus of claim 1, wherein the controller is configured to calculate, based on vehicle information and driving information of the vehicle, the reference prediction value corresponding to at least one of the plurality of pieces of information, wherein the vehicle information and the driving information are comprised in the dataset,
wherein the vehicle information comprises at least one of: a model of the vehicle, a production time of the vehicle, a failure code of the vehicle, engine state information of the vehicle, or battery information of the vehicle, and
wherein the driving information comprises at least one of: fuel efficiency of the vehicle, a driving distance of the vehicle, or a driving speed of the vehicle.

6. The apparatus of claim 1, wherein the plurality of pieces of information comprised in the dataset comprise at least one of: driving information, vehicle information, part information, or characteristic information associated with the vehicle,
wherein the controller is configured to calculate a plurality of reference prediction values comprising a driving information reference prediction value, a vehicle information reference prediction value, a part information reference prediction value, and a characteristic information reference prediction value, and
wherein each reference prediction value of the plurality of reference prediction values respectively corresponds to one of the plurality of pieces of information.

7. The apparatus of claim 1, wherein the controller is configured to transmit, to the electronic device, failure prediction information comprising the reference prediction value and the comparison result.

8. The apparatus of claim 7, wherein the controller is configured to receive, from the electronic device, a dataset updated based on the failure prediction information after transmitting the failure prediction information.

9. The apparatus of claim 1, wherein the plurality of parts comprise a brake pad, and
wherein the controller is configured to:
select a brake pedal ON time accumulation value as the signal;
collect, based on the first policy, the signal;
calculate the reference prediction value using a brake pad replacement time comprised in the dataset;
compare the calculated reference prediction value with the real-time driving information by comparing the brake pedal ON time accumulation value identified based on the collected signal with the calculated reference prediction value; and
display, on a display device and based on the brake pedal ON time accumulation value being greater than the reference prediction value, the comparison result comprising information indicating that it is necessary to replace the brake pad.

10. The apparatus of claim 9, wherein the controller is configured to reset, based on the brake pad being replaced, the brake pedal ON time accumulation value and display, on the display device, a user interface comprising information indicating that the brake pad is replaced.

11. A method comprising:
collecting, by a sensor device, real-time driving information of a vehicle and real-time state information of the vehicle;
receiving, by a controller, a dataset associated with the vehicle from an electronic device;
selecting, by the controller and based on at least a portion of the dataset, a signal for collecting pieces of information of a plurality of parts of the vehicle;
identifying, by the controller, at least one policy associated with the selected signal;
selecting, by the controller and based on the at least a portion of the dataset, a first policy associated with the signal among the at least one policy;
collecting, by the controller and based on the selected first policy, the signal;
calculating, by the controller and based on the at least a portion of the dataset, a reference prediction value corresponding to at least one of a plurality of pieces of information comprised in the dataset;
comparing, by the controller, the calculated reference prediction value with at least one of:
the real-time driving information; or the real-time state information; and
determining, by the controller and using a comparison result associated with the calculated reference prediction value, states of the plurality of parts.

12. The method of claim 11, wherein the selecting the first policy comprises:
selecting, based on vehicle information and driving information of the vehicle, the first policy among the at least one policy, wherein the vehicle information and the driving information are comprised in the dataset; and
wherein the determining the states of the plurality of parts comprises:
determining, based on a comparison of the signal collected based on the first policy with the reference prediction value, whether there is a failure in at least one of the plurality of parts or whether it is necessary to replace at least one of the plurality of parts.

13. The method of claim 11, wherein the selecting the first policy comprises:
determining or updating, based on the at least a portion of the dataset, a condition value for collecting the signal, wherein the condition value is comprised in the first policy, and
wherein the condition value comprises at least one of: a collection period for collecting the signal, a trigger signal, a collection period of time, or a state of the vehicle.

14. The method of claim 11, wherein the calculating the reference prediction value corresponding to at least one of the plurality of pieces of information comprised in the dataset comprises:
calculating, based on pieces of part information about the plurality of parts of the vehicle, the reference prediction value corresponding to at least one of the plurality of pieces of information, wherein the pieces of part information are comprised in the dataset, and
wherein the pieces of part information comprise at least one of: a part production time, a part model, a part number, or a part application vehicle.

15. The method of claim 11, wherein the calculating the reference prediction value corresponding to at least one of the plurality of pieces of information comprised in the dataset comprises:
calculating, based on vehicle information and driving information of the vehicle, the reference prediction value corresponding to at least one of the plurality of pieces of information, wherein the vehicle information and the driving information are comprised in the dataset,
wherein the vehicle information comprises at least one of: a model of the vehicle, a production time of the vehicle, a failure code of the vehicle, engine state information of the vehicle, or battery information of the vehicle, and
wherein the driving information comprises at least one of: fuel efficiency of the vehicle, a driving distance of the vehicle, or a driving speed of the vehicle.

16. The method of claim 11, wherein the plurality of pieces of information comprised in the dataset comprise at least one of: driving information, vehicle information, part information, or characteristic information associated with the vehicle,
wherein the calculating the reference prediction value comprises:
calculating a plurality of reference predication values comprising a driving information reference prediction value, a vehicle information reference prediction value, a part information reference prediction value, and a characteristic information reference prediction value, and
wherein each reference prediction value of the plurality of reference prediction values respectively corresponds to one of the plurality of pieces of information.

17. The method of claim 11, further comprising:
transmitting, by the controller to the electronic device, failure prediction information comprising the reference prediction value and the comparison result.

18. The method of claim 17, further comprising:
receiving, by the controller from the electronic device, a dataset updated based on the failure prediction information after transmitting the failure prediction information.

19. The method of claim 11, wherein the plurality of parts comprise a brake pad, and
wherein the method further comprises:
selecting, by the controller, a brake pedal ON time accumulation value as the signal;
collecting, by the controller and based on the first policy, the signal;
calculating, by the controller, the reference prediction value using a brake pad replacement time comprised in the dataset;
comparing, by the controller, the calculated reference prediction value with the real-time driving information by comparing the brake pedal ON time accumulation value identified based on the collected signal with the calculated reference prediction value; and
displaying, on a display device and based on the brake pedal ON time accumulation value being greater than the reference prediction value, the comparison result comprising information indicating that it is necessary to replace the brake pad.

20. A method comprising:
collecting, by a sensor device, driving information of a vehicle and state information associated with at least one vehicle part of the vehicle;
receiving, from an external device and via a communication interface, a dataset associated with the vehicle;
selecting, by a controller and based on at least a portion of the dataset, a signal type for collecting pieces of information associated with the at least one vehicle part of the vehicle;
collecting, by the controller and based on at least one policy associated with the selected signal type, at least one signal associated with the signal type;
after collecting the at least one signal, calculating, by the controller and based on the at least a portion of the dataset, a reference prediction value;
comparing, by the controller, the calculated reference prediction value with at least one of:
the driving information; or the state information; and
diagnosing, by the controller and using a comparison result associated with the calculated reference prediction value, a state of the at least one vehicle part.
